(19) United States
(12) Patent Application Publication
(10) Pub. No.: US 2024/0380854 A1
(43) Pub. Date: Nov. 14, 2024

(54) IMAGE FORMING APPARATUS THAT DECIDES IMAGE QUALITY

(71) Applicant: KYOCERA Document Solutions Inc., Osaka (JP)

(72) Inventor: Kenichi HAYASHI, Osaka (JP)

(73) Assignee: KYOCERA Document Solutions Inc., Osaka (JP)

(21) Appl. No.: 18/651,858

(22) Filed: May 1, 2024

(30) Foreign Application Priority Data
May 10, 2023 (JP) 2023-077906

(51) Int. Cl. H04N 1/00

(52) U.S. Cl. CPC H04N 1/00769; H04N 1/00724

(57) ABSTRACT

An image forming apparatus includes a reading device, an identifier, a determiner, and a decider. The reading device reads, from a sheet, information related to the sheet. The identifier identifies a type of the sheet, on a basis of the information related to the sheet. The determiner determines a threshold for quality of an image, on a basis of the information related to the sheet, and the identified type of the sheet. The decider decides the quality of the image formed on the sheet, on a basis of the threshold.

### INCORPORATION BY REFERENCE

This application claims priority to Japanese Patent Application No. 2023-077906 filed on May 10, 2023, the entire contents of which are incorporated by reference herein.

### BACKGROUND

The present disclosure relates to an image forming apparatus.

An image forming apparatus is known that includes an acquisition device that acquires a feature from a chart generated by an image forming device, a decision device that decides whether a defect is contained in an image, on the basis of the acquired feature, and a notification device that notifies the decision result.

### SUMMARY

The disclosure proposes further improvement of the foregoing techniques.

In an aspect, the disclosure provides an image forming apparatus including a reading device, an identifier, a determiner, and a decider. The reading device reads, from a sheet, information related to the sheet. The identifier identifies a type of the sheet, on a basis of the information related to the sheet. The determiner determines a threshold for quality of an image, on a basis of the information related to the sheet, and the identified type of the sheet. The decider decides the quality of the image formed on the sheet, on a basis of the threshold.

### BRIEF DESCRIPTION OF THE DRAWINGS

FIG. 1 is a schematic cross-sectional view showing an image forming apparatus according to an embodiment of the disclosure;

FIG. 2 is a block diagram showing a configuration of the image forming apparatus according to the embodiment;

FIG. 3 is a graph showing changes in index based on tile size;

FIG. 4 is a flowchart showing an operation executed by a controller of the image forming apparatus according to the embodiment;

FIG. 5 is a flowchart showing a process of identifying the type of sheet, executed by the controller of the image forming apparatus according to the embodiment;

FIG. 6 is a flowchart showing a process of determining a threshold with respect to image quality, executed by the controller of the image forming apparatus according to the embodiment; and

FIG. 7 is a flowchart showing a process of deciding image quality, executed by the controller of the image forming apparatus according to the embodiment.

### DETAILED DESCRIPTION

Hereafter, an image forming apparatus according to an embodiment of the disclosure will be described, with reference to the drawings. In the drawings, the same or corresponding elements are given the same numeral, and the description of such elements will not be repeated.

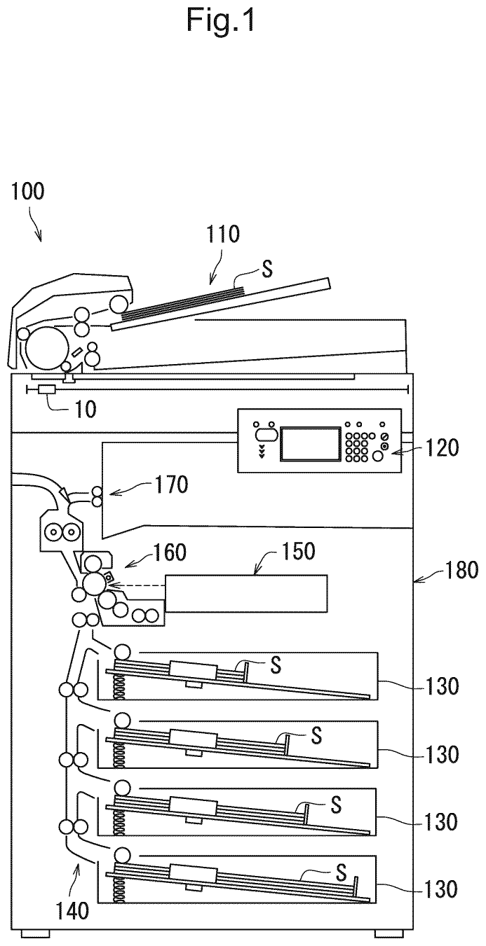

Referring to FIG. 1, the image forming apparatus 100 according to the embodiment of the disclosure will be described. FIG. 1 is a schematic cross-sectional view of the image forming apparatus 100.

The image forming apparatus 100 includes a reading device 110, an operation device 120, a sheet storage 130, a sheet transport device 140, a supply device 150, an image forming device 160, a delivery device 170, and a casing 180. The sheet storage 130, the sheet transport device 140, the supply device 150, the image forming device 160, and the delivery device 170 are accommodated inside the casing 180.

The reading device 110 reads, from a sheet S, information related to the sheet S. The reading device 110 may be, for example, a scanner. The reading device 110 also reads an image formed on the sheet S. The reading device 110 includes a contact glass, a platen cover, a light emitting device, and an image sensor 10. On the contact glass, the sheet S is placed. The platen cover is for covering the contact glass. The light emitting device may be, for example, a light emitting diode (LED). The image sensor 10 reads, for example, surface roughness of the sheet S, as the information related thereto. The surface roughness of the sheet S indicates how coarse, or how smooth, the surface of the sheet S is.

The image sensor 10 may be, for example, a charge-coupled device (CCD). The image sensor 10 is provided with an optical system that reciprocates along the contact glass on which the sheet S is placed, and configured to emit light from the optical system to the sheet S, and reflect the light reflected by the sheet S toward the CCD. The CCD generates an electrical signal representing the image formed on the sheet S, on the basis of the reflected light acquired from the optical system. The electrical signal indicates the density (brightness) of the image on the surface of the sheet S. The image sensor 10 outputs the electrical signal generated as above to the controller 20, as image data representing the image acquired through the reading operation of the sheet S.

The operation device 120 is for receiving instructions to the image forming apparatus 100, inputted by a user. The operation device 120 includes a touch panel and a plurality of operation keys.

In the sheet storage 130, a plurality of sheets S are accommodated. The sheet storage 130 delivers the plurality of sheets S accommodated therein, one by one. The sheet storage 130 includes a plurality of trays inside the image forming apparatus 100. The sheets S, stored in the respective trays of the sheet storage 130, are different in type from each other. Examples of the type of the sheet S include smooth paper, rough paper, and embossed paper. Here, the smooth paper exemplifies the “first sheet” in the disclosure. The rough paper exemplifies the “second sheet” in the disclosure. The embossed paper exemplifies the “third sheet” in the disclosure.

The sheet transport device 140 transports the sheet S delivered from the sheet storage 130, to the delivery device 170.

The supply device 150 includes a toner container loaded with toner, and a supply mechanism that supplies the toner from the toner container to a developing device of the image forming device 160.

The image forming device 160 uses the toner to form an image on the sheet S. Here, the image refers to a toner image.

The image forming device 160 includes a photoconductor drum, a charging device, an exposure device, the developing device, a transfer roller, and a cleaning device.

The charging device electrically charges the circumferential surface of the photoconductor drum. The exposure device irradiates the circumferential surface of the photoconductor drum, charged by the charging device, with a laser beam. The laser beam is generated on the basis of the image data. Accordingly, an electrostatic latent image based on the image data is formed on the circumferential surface of the photoconductor drum.

The developing device supplies the toner to the circumferential surface of the photoconductor drum, on which the electrostatic latent image has been formed. When the developing device supplies the toner to the photoconductor drum, the electrostatic latent image, formed on the circumferential surface of the photoconductor drum, is developed. As result, the image formed of the toner appears, on the circumferential surface of the photoconductor drum.

The photoconductor drum is in contact with the circumferential surface of the transfer roller. When the sheet S passes through between the photoconductor drum and the transfer roller, the image carried by the photoconductor drum is transferred to the sheet S. After the image is transferred to the sheet S, the cleaning device removes the toner remaining on the circumferential surface of the photoconductor drum.

The delivery device 170 delivers the sheet S, on which the toner image has been fixed, from inside of the casing 180 to an output tray, through a sheet delivery port.

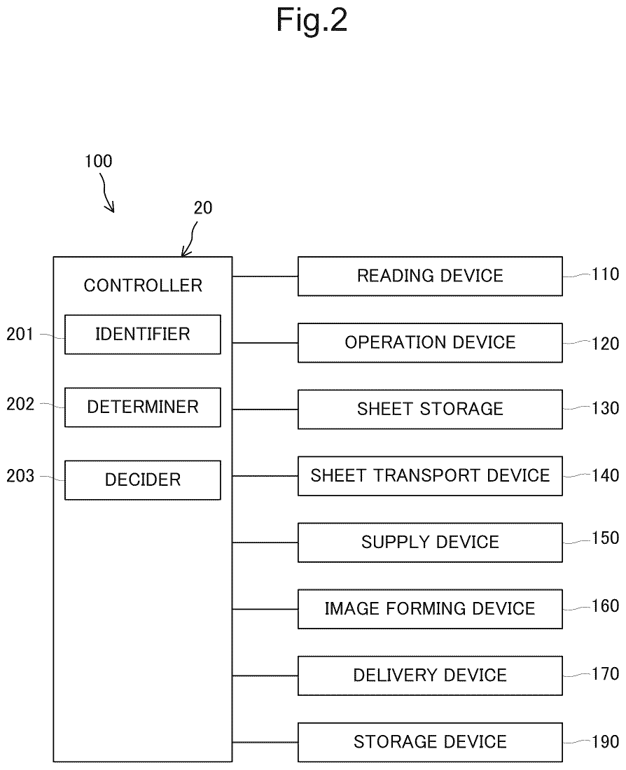

Referring now to FIG. 2, the image forming apparatus 100 will be described in further detail. FIG. 2 is a block diagram showing a configuration of the image forming apparatus 100.

As shown in FIG. 2, the image forming apparatus 100 further includes a storage device 190 and a controller 20.

The storage device 190 includes memory units. The memory units include a main memory unit such as a read-only memory (ROM) and a random-access memory (RAM), and may also include an auxiliary memory unit. The main memory unit may be, for example, a semiconductor memory. The auxiliary memory unit may be, for example, a hard disk drive and a non-volatile memory. The main memory unit and/or the auxiliary memory unit contain various computer programs, to be executed by the controller 20. The computer programs include a program for executing an image forming operation.

The storage device 190 contains reference thresholds to be used for deciding the image quality, predetermined with respect to each type of the sheet S. The reference threshold indicates the level of the image quality, by a numeric value. The reference threshold is expressed by a value indicating a predetermined level of the image quality. For example, the number of fixing defects may be adopted as the criterion for deciding the image quality. The fixing defect refers to the case where an image, not in accordance with the image data expected to be outputted, is outputted. The number of fixing defects may include, for example, the number of points dried out by fixing, the number of unnecessary lines that have appeared in the image, and the number of stains in the image. A value indicating a permissible number of fixing defects, from the viewpoint of securing an acceptable level of the image quality, is adopted as the reference threshold.

The controller 20 includes a processor such as a central processing unit (CPU) or a micro processing unit (MPU). The controller 20 controls the functional elements of the image forming apparatus 100. To be more specific, the controller 20 controls the reading device 110, the operation device 120, the sheet transport device 140, the supply device 150, the image forming device 160, the delivery device 170, and the storage device 190, when the processor in the controller 20 executes the computer program stored in the memory unit.

The controller 20 includes an identifier 201, a determiner 202, and a decider 203. To be more specific, the controller 20 acts as the identifier 201, the determiner 202, and the decider 203, by executing the computer program stored in the storage device 190.

The identifier 201 identifies the type of the sheet S, on the basis of the information related thereto (surface roughness of sheet S).

The determiner 202 retrieves the reference threshold corresponding to the type of the sheet S identified by the identifier 201, from the storage device 190, to thereby determine the reference threshold for the image quality.

The decider 203 decides the quality of the image formed on the sheet S, on the basis of the reference threshold for the image quality. In other words, the image quality is decided on the basis of the surface roughness, which is the characteristic of the sheet S. Such an arrangement improves the accuracy in evaluating the image quality. The decision of the image quality according to this embodiment refers to deciding, with respect to a printed material obtained by forming an image on the sheet S, with the image forming device 160 of the image forming apparatus 100, which level of image quality has been attained by the image formed on the printed material.

The information related to the sheet S (surface roughness of sheet S) may be stored in advance in the storage device 190. In this case, the user may input the information about the sheet S in the storage device 190, for example according to a paper catalogue indicating the types of the sheet and the surface roughness of each of the types. In this case, the identifier 201 identifies the type of the sheet S on the basis of the information about the sheet S stored in the storage device 190, instead of identifying the type of the sheet S on the basis of the image data read by the reading device 110.

As described above, the information about the sheet S includes the value indicating the surface roughness of the sheet S. The reading device 110 reads the surface of the sheet S, and outputs the information that has been read (image data) to the controller 20. The identifier 201 calculates the value indicating the surface roughness of the sheet S, on the basis of the information that has been read. For example, the identifier 201 may calculate the value of the surface roughness of the sheet S, corresponding to the image data represented by the information acquired through the reading operation by the reading device 110, using a learned model M, generated through the learning of the relation between a plurality of pieces of image data, acquired by the reading device 110 from the surface of the sheet S, and the values indicating the surface roughness of the sheet S respectively corresponding to the image data. The image data represented by the information that has been read may be expressed, for example, by an RGB value. Further, the image data that has been subjected to shading, to which an image processing such as gamma correction is not applied, may be adopted as the image data represented by the information that has been read.

The learned model M may be generated, for example, through machine learning utilizing the artificial intelligence (AI). The machine learning includes a convolutional neural network (CNN). The convolutional neural network extracts features from an image. For example, the process of the convolutional neural network may be executed on a personal computer, to thereby generate the learned model M, by finding the characteristic of the image data, corresponding to the value indicating the surface roughness. Then the learned model M generated on the personal computer may be stored in the storage device 190 of the image forming apparatus 100. The identifier 201 calculates, utilizing the learned model M, the value of the surface roughness of the sheet S, corresponding to the image data represented by the information acquired through the reading operation by the reading device 110.

Then the identifier 201 identifies the type of the sheet S, on the basis of the value indicating the surface roughness of the sheet S. The sheets S present different values of the surface roughness, depending on the type. The types of the sheet S corresponding to the respective values of the surface roughness of the sheet S (e.g., smooth paper, rough paper, and embossed paper) may be stored in advance in the identifier 201, so that the identifier 201 may identify the type of the sheet S, in view of the correspondence between the value of the surface roughness and the type of the sheet S. Such an arrangement enables the type of the sheet S to be easily identified.

The identifier 201 may contain, in advance, permissible standard deviation of the value indicating the surface roughness of the sheet S, corresponding to the type thereof, as a range of the values indicating the surface roughness of the sheet S, with respect to each of the types of the sheet S. In this case, the accuracy in identifying the type of the sheet S with the identifier 201 can be improved.

As described above, the identifier 201 identifies the type of the sheet S, on the basis of the value indicating the surface roughness of the sheet S.

The identifier 201 may identify the type of the sheet S, by a different method as described hereunder. The identifier 201 may clip out the image data, based on the information read by the reading device 110, in a patch of a predetermined size, and divide the patch into a predetermined number of tiles. The patch size may be, for example, a square of 12.7 mm. The tile size may be, for example, “10×10”. In other words, one patch contains 100 pieces of tiles.

It is preferable that the tile size for calculating the standard deviation is 10 (10×10) or larger. More preferably, the tile size for calculating the standard deviation may be 15 (15×15) or larger. Setting the tile size to a value equal to or larger than 10 (10×10) leads to improved accuracy in identifying the type of the sheet S with the identifier 201.

The identifier 201 then calculates the standard deviation, using average values obtained from a predetermined pixel value for each tile. The predetermined pixel value may be, for example, 900 dots. The predetermined pixel value may be expressed by a luminance value or an RGB value.

The standard deviation of the surface roughness may be calculated through the following equation (1) or equation (2).

$$[ Math . 1 ]$$

$$Standard Deviation ( L ) = \sqrt{\frac{1}{n - 1} {\sum }_{i = 1}^{n} ( {m}_{Li} - {m}_{{Lave )}^{2}} ( n = 1 , 2 , … , 100 )} \qquad ( Equation 1 )$$

In the equation (1), “L” represents the standard deviation of the luminance value, “n” represents a natural number from 1 to 100, “mLi” represents the luminance value acquired, and “mLave” represents the average of the luminance values.

$$[ Math . 2 ]$$

$$Standard Deviation ( R G B ) = \sqrt{\frac{1}{n - 1} {\sum }_{i = 1}^{n} {( {m}_{RGBi} {m}_{RBGave} )}^{2} ( n = 1 , 2 , … , 100 )} \qquad ( Equation 2 )$$

In the equation (2), “RGB” represents the standard deviation of the RGB value, “n” represents a natural number from 1 to 100, “mRGBi” represents the RGB value acquired, and “mRGBave” represents the average of the RGB values.

The identifier 201 then calculates an index k, indicating the surface roughness of the sheet S. The index k is calculated from the quotient obtained by dividing the standard deviation stored in the storage device 190 by the standard deviation calculated by the identifier 201. The identifier 201 identifies the type of the sheet S, on the basis of the index k.

To be more specific, the identifier 201 decides whether the index k indicating the surface roughness of the sheet S is smaller than a threshold for the surface roughness of a specific sheet. Then the identifier 201 identifies the type of the sheet S, on the basis of the decision result. Accordingly, the identifier 201 can decide whether the sheet S is the specific sheet, on the basis of the threshold for the surface roughness of the specific sheet. Therefore, the accuracy in identifying the sheet S can be improved.

The threshold for the surface roughness includes a first surface threshold and a second surface threshold. The second surface threshold is larger than the first surface threshold.

The identifier 201 decides whether the value indicating the surface roughness of the sheet S is smaller than the first surface threshold. When the value indicating the surface roughness of the sheet S is smaller than the first surface threshold, the identifier 201 identifies the sheet S as the smooth paper. When the value indicating the surface roughness of the sheet S is not smaller than the first surface threshold, the identifier 201 decides whether the value indicating the surface roughness of the sheet S is smaller than the second surface threshold. When the value indicating the surface roughness of the sheet S is smaller than the second surface threshold, the identifier 201 identifies the sheet S as the rough paper, not the smooth paper. When the value indicating the surface roughness of the sheet S is not smaller than the second surface threshold, the identifier 201 identifies the sheet S as the embossed paper, not the smooth paper or the rough paper. By utilizing thus the first surface threshold and the second surface threshold, the identifier 201 can identify the type of the sheet S with higher accuracy.

The determiner 202 determines the threshold related to the image quality, on the basis of the information about the sheet S, and the type of the sheet S that has been identified. In this process, the determiner 202 may determine an offset amount with respect to the threshold related to the image quality, on the basis of the value indicating the surface roughness of the sheet S. The threshold related to the image quality may indicate, for example, the number of fixing defects. To be more specific, the determiner 202 determines the threshold for the fixing defects, on the basis of the information about the sheet S, and the type of the sheet S that has been identified. Further, the determiner 202 may determine, for example, the threshold for the extent of drying out by fixing, on the basis of the information about the sheet S, and the type of the sheet S that has been identified.

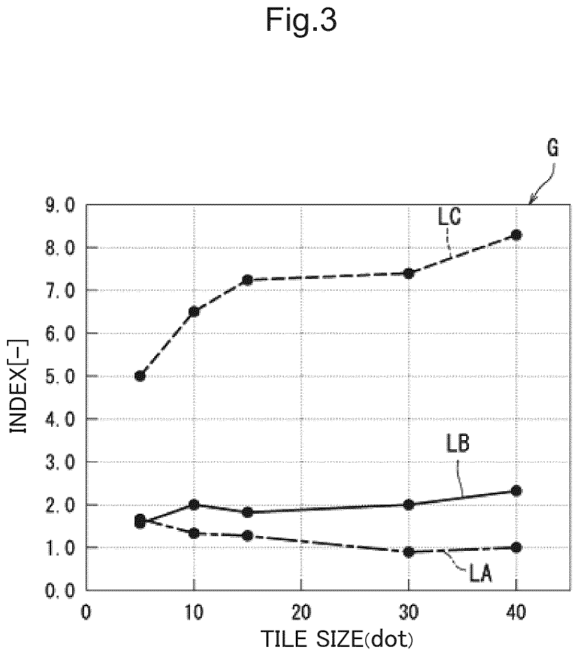

FIG. 3 is a graph showing changes in index k, based on tile size. The horizontal axis in FIG. 3 represents the tile size. The range of the tile size is from 0 to 40. The vertical axis of FIG. 3 represents the index k. The range of the index k is from 0.0 to 9.0. FIG. 3 includes polylines LA, polylines LB, and polylines LC. The polylines LA represent the changes in index based on the tile size, with respect to a sheet SA. The polylines LB represent the changes in index based on the tile size, with respect to a sheet SB. The polylines LC represent the changes in index based on the tile size, with respect to a sheet SC. The sheet SA corresponds to the smooth paper. The sheet SB corresponds to the rough paper. The sheet SC corresponds to the embossed paper.

In the case of the sheet SA, the index is 1.7 when the tile size is 5 (5×5); the index is 1.4 when the tile size is 10 (10×10); the index is 1.3 when the tile size is 15 (15×15); the index is 0.9 when the tile size is 30 (30×30); and the index is 1.0 when the tile size is 40 (40×40).

In the case of the sheet SB, the index is 1.6 when the tile size is 5 (5×5); the index is 2.0 when the tile size is 10 (10×10); the index is 1.8 when the tile size is 15 (15×15); the index is 2.0 when the tile size is 30 (30×30); and the index is 2.3 when the tile size is 40 (40×40).

In the case of the sheet SC, the index is 5.0 when the tile size is 5 (5×5); the index is 6.5 when the tile size is 10 (10×10); the index is 7.3 when the tile size is 15 (15×15); the index is 7.4 when the tile size is 30 (30×30); and the index is 8.3 when the tile size is 40 (40×40).

Further, the first surface threshold may be, for example, 1.5. The second surface threshold may be, for example, 3.8. The first surface threshold and the second surface threshold may be set to desired values.

As shown in FIG. 3, for the tile size of 5 (5×5), the index of the sheet SA is 1.7, and the index of the sheet SB is 1.6. Thus, the index of the sheet SA and the index of the sheet SB are larger than the first surface threshold, but smaller than the second surface threshold. Accordingly, the identifier 201 can identify the sheet SA and the sheet SB as the second sheet. In other words, the identifier 201 identifies the sheet SA and the sheet SB as the rough paper.

However, for the tile size of 10 (10×10), the index of the sheet SA is 1.4″, and the index of the sheet SB is 2.0. Accordingly, since the index of the sheet SA is smaller than the first surface threshold, the identifier 201 can identify the sheet SA as the first sheet. In contrast, since the index of the sheet SB is larger than the first surface threshold, the identifier 201 decides whether the index of the sheet SB is smaller than the second surface threshold. Then, since the index of the sheet SB is smaller than the second surface threshold, the identifier 201 can identify the sheet SB as the second sheet. As described above, when the tile size is 10 or larger, the identifier 201 can identify the type of the sheet S with higher accuracy.

Further, as shown in FIG. 3, the index of the sheet SC is larger than the second surface threshold, in the tile size range of 5 (5×5) to 40 (40×40). Accordingly, the identifier 201 can identify the sheet SC as the third sheet. In other words, the identifier 201 can identify the sheet SC as the embossed paper.

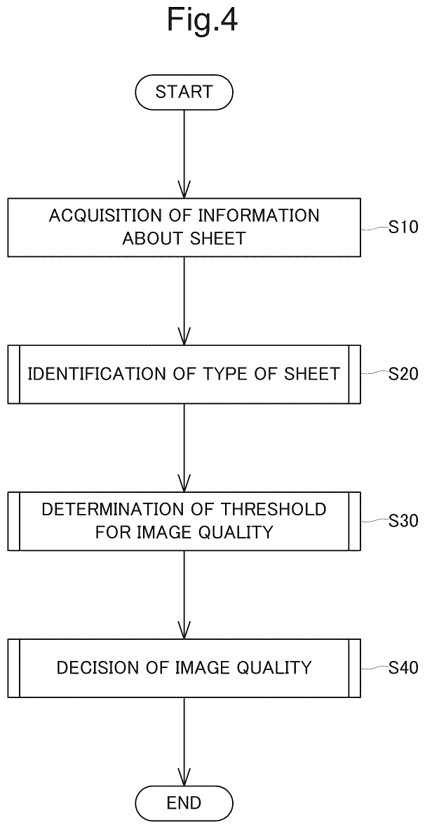

Referring now to FIG. 4 to FIG. 7, the operation executed by the controller 20 of the image forming apparatus 100 according to this embodiment will be described hereunder. FIG. 4 is a flowchart showing the operation executed by the controller 20 of the image forming apparatus 100 according to this embodiment. The operation executed by the controller 20, shown in FIG. 4, includes step S10 to step S40. This operation is for deciding the image quality, in other words, as mentioned above, deciding with respect to the printed material obtained by forming an image on the sheet S, with the image forming device 160 of the image forming apparatus 100, which level of image quality has been attained by the image formed on the printed material.

At step S10, the controller 20 controls the reading device 110, so as to acquire the information related to the surface of the sheet S. Then the operation proceeds to step S20.

At step S20, the controller 20 executes the operation for identifying the type of the sheet S. To be more specific, the operation for identifying the sheet S includes causing the identifier 201 to identify the type of the sheet S, on the basis of the information related to the sheet S. Then the operation proceeds to step S30.

At step S30, the controller 20 executes the operation for determining the threshold for the image quality. To be more specific, the operation for determining the threshold for the image quality includes causing the determiner 202 to determine the threshold for the image quality, on the basis of the information related to the sheet S and the type of the sheet S that has been identified. Then the operation proceeds to step S40.

At step S40, the controller 20 executes the operation for deciding the image quality. To be more specific, the operation for deciding the image quality includes causing the decider 203 to decide the quality of the image formed on the sheet S, on the basis of the threshold.

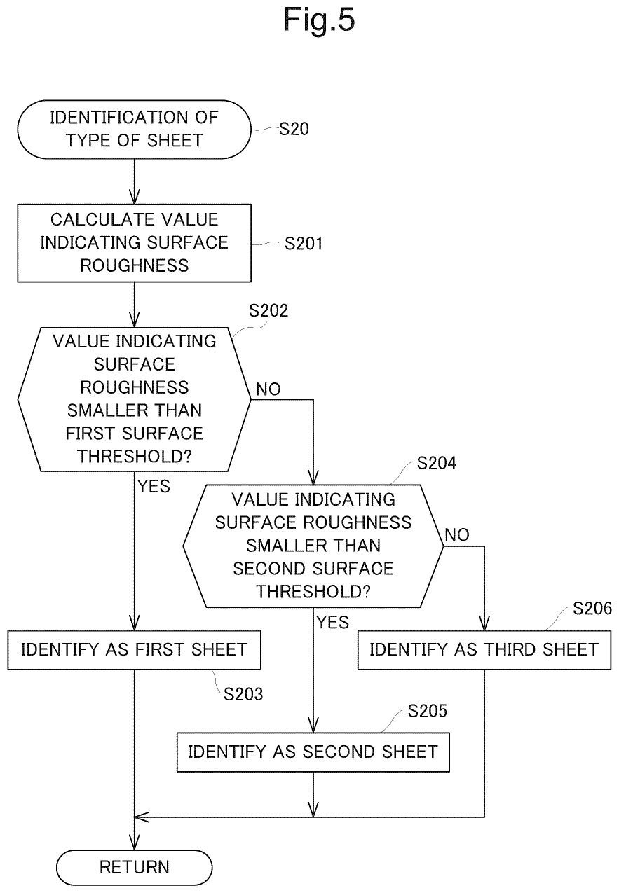

Referring to FIG. 5, a process of identifying the type of the sheet S will be described in detail. FIG. 5 is a flowchart showing the process of identifying the type of sheet. The process of identifying the type of the sheet S includes step S201 to step S206.

At step S201, the identifier 201 calculates the value of the surface roughness, utilized as the information related to the sheet S, or the index k. In the case of calculating the index k, the identifier 201 calculates the index k indicating the surface roughness of the sheet S, on the basis of the information related to the sheet S, acquired by the reading device 110. Then the operation proceeds to step S202. Hereinafter, the term “value indicating the surface roughness of the sheet S” will be construed as including the index k.

At step S202, the identifier 201 decides whether the value indicating the surface roughness of the sheet S is smaller than the first surface threshold. When the value indicating the surface roughness of the sheet S is not smaller than the first surface threshold (No at step S202), the operation proceeds to step S204. When the value indicating the surface roughness of the sheet S is smaller than the first surface threshold (Yes at step S202), the operation proceeds to step S203.

In the case of “Yes” at step S202, the identifier 201 identifies the sheet S as the first sheet (step S203). In other words, the identifier 201 identifies the sheet S as the smooth paper. Then the operation returns to step S30 shown in FIG. 4.

In the case of “No” at step S202, the identifier 201 decides whether the value indicating the surface roughness of the sheet S is smaller than the second surface threshold (step S204). When the value indicating the surface roughness of the sheet S is not smaller than the second surface threshold (No at step S204), the operation proceeds to step S206. When the value indicating the surface roughness of the sheet S is smaller than the second surface threshold (Yes at step S204), the operation proceeds to step S205.

In the case of “Yes” at step S204, the identifier 201 identifies the sheet S as the second sheet (step S205). In other words, the identifier 201 identifies the sheet S as the rough paper, not the smooth paper. Then the operation returns to step S30 shown in FIG.

In the case of “No” at step S204, the identifier 201 identifies the sheet S as the third sheet (step S206). In other words, the identifier 201 identifies the sheet S as the embossed paper, not the smooth paper or the rough paper. Then the operation returns to step S30 shown in FIG. 4.

In this embodiment, the identifier 201 identifies the type of the sheet S utilizing the first and second surface thresholds, including the case where the identifier 201 employs the value of the surface roughness, instead of calculating the index k to identify the type of the sheet S. In this case, the value indicating the surface roughness of the sheet S, smaller than the first surface threshold, corresponds to the smooth paper. The value indicating the surface roughness of the sheet S, equal to or larger than the first surface threshold and smaller than the second surface threshold, corresponds to the rough paper. The value indicating the surface roughness of the sheet S, equal to or larger than the second surface threshold corresponds to the embossed paper.

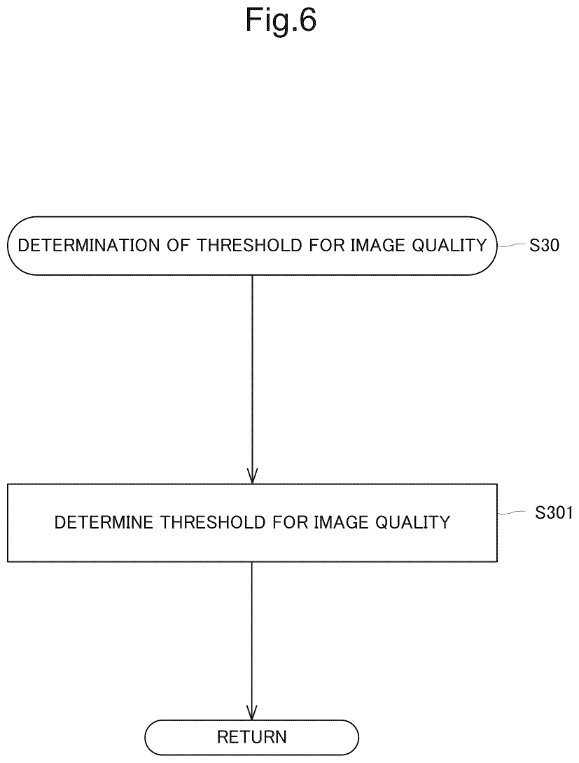

Referring to FIG. 6, a process of determining the threshold for the image quality will be described in detail. FIG. 6 is a flowchart showing the process of determining the threshold for the image quality. The process of determining the threshold for the image quality includes step S301.

At step S301, the determiner 202 determines the threshold for the image quality, on the basis of the information related to the sheet S, and the type of the sheet S that has been identified.

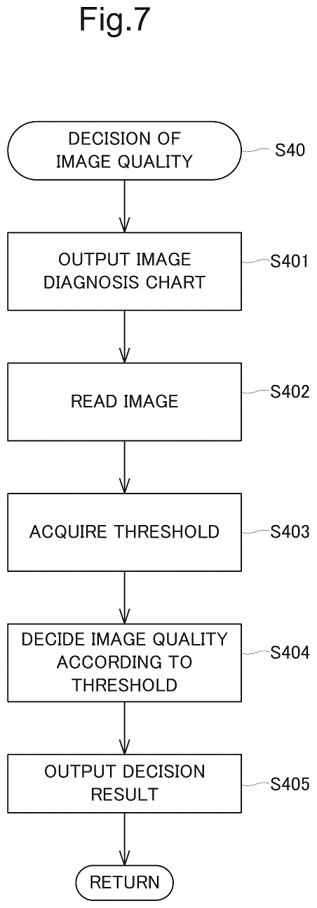

Referring to FIG. 7, a process of deciding the image quality will be described in detail. FIG. 7 is a flowchart showing the process of deciding the image quality. The process of deciding the image quality includes step S401 to step S405.

At step S401, the controller 20 controls the image forming device 160 so as to output an image diagnosis chart onto the sheet S. The image diagnosis chart may be, for example, a halftone chart of the toner of a predetermined color. The image diagnosis chart may be constituted of halftone data.

At step S402, the controller 20 controls the reading device 110 so as to read the image diagnosis chart. Then the operation proceeds to step S403.

At step S403, the controller 20 acquires the reference threshold to be used for the decision of the image quality. Then the operation proceeds to step S404.

At step S404, the controller 20 decides the image quality, using the reference threshold for the image quality. For example, the decider 203 compares, with a pattern matching technique, between an image stored in advance, and presenting an ideal image diagnosis chart, and the image corresponding to the image diagnosis chart actually formed on the sheet S, and read by the reading device 110. The decider 203 decides, for example, whether an image not included in the image presenting the ideal image diagnosis chart, in other word a bug, is included in the image corresponding to the image diagnosis chart read by the reading device 110, and calculates the number of such bugs, as a quality degradation value indicating the extent of the quality degradation. Then the decider 203 decides whether the quality degradation value is larger than the reference threshold used for the decision of the image quality. Upon deciding that the quality degradation value is larger than the reference threshold used for the decision of the image quality, the decider 203 decides that the image quality is “low”. In contrast, upon deciding that the quality degradation value is equal to or smaller than the reference threshold used for the decision of the image quality, the decider 203 decides that the image quality is “high”. Then the operation proceeds to step S405.

At step S405, the controller 20 outputs the decision result indicating the image quality. For example, the controller 20 causes the image forming device 160 to form the image representing the decision result, on the sheet S. Thereafter, the operation returns to the flowchart shown in FIG. 4.

When the decider 203 decides, at step S404, the image quality on the basis of the reference threshold, the user can decide, for example, whether any points dried out by fixing are contained in the image, on the basis of the decision result.

In the case of the aforementioned known image forming apparatus, the information related to the sheet, on which an image is yet to be formed, is not taken into account. Therefore, it is difficult to evaluate the quality of the image formed on the sheet, with the surface status of the sheet included in the evaluation criteria. As result, the accuracy in diagnosing the image quality is unable to be improved.

In contrast, according to the foregoing embodiment, the information based on the property of the sheet itself (e.g., surface roughness of the sheet), acquired irrespective of whether an image is formed thereon, is incorporated in the decision criteria, when the image quality of the printed material, formed by the image forming apparatus 100, is to be evaluated. Therefore, the accuracy in diagnosing the image quality of the printed material can be improved.

Further, the information indicating the characteristic of the sheet S may include at least one of the information indicating the brand of the sheet S, the information indicating the color of the sheet S, the information indicating the thickness of the sheet S, and the information indicating the type of the sheet S.

The embodiment of the disclosure has been described as above, with reference to the drawings. However, the disclosure is not limited to the foregoing embodiment, but may be modified in various manners, without departing from the scope of the disclosure. The drawings each schematically illustrate the elements for the sake of clarity, and the thickness, length, number of pieces, and interval of the illustrated elements may be different from the actual ones, because of the convenience in making up the drawings. Further, the material, shape, and size of the elements referred to in the foregoing embodiment are merely exemplary and not specifically limited, and may be modified as desired, without substantially departing from the configuration according to the disclosure.

### INDUSTRIAL APPLICABILITY

The disclosure provides the image forming apparatus, and is therefore industrially applicable.

What is claimed is:

1. An image forming apparatus comprising:
a reading device that reads, from a sheet, information related to the sheet;
an identifier that identifies a type of the sheet, on a basis of the information related to the sheet;
a determiner that determines a threshold for quality of an image, on a basis of the information related to the sheet, and the identified type of the sheet; and
a decider that decides the quality of the image formed on the sheet, on a basis of the threshold.

2. The image forming apparatus according to claim 1, further comprising a storage device storing therein a reference threshold with respect to each type of the sheet,
wherein the determiner determines the reference threshold, by retrieving from the storage device the reference threshold corresponding to the type of the sheet identified by the identifier.

3. The image forming apparatus according to claim 2,
wherein the information related to the sheet includes a value indicating surface roughness of the sheet, and
the identifier identifies the type of the sheet, on a basis of the value indicating the surface roughness of the sheet.

4. The image forming apparatus according to claim 2,
wherein the identifier identifies the type of the sheet, on a basis of standard deviation of the value indicating the surface roughness of the sheet.

5. The image forming apparatus according to claim 4,
wherein the identifier calculates the standard deviation, by clipping out the information related to the sheet in a form of a patch of a predetermined size, and dividing the patch into equal to or larger than a predetermined number of tiles.

6. The image forming apparatus according to claim 3,
wherein the identifier identifies the type of the sheet, by deciding whether the value indicating the surface roughness of the sheet is smaller than a threshold for surface roughness of a specific sheet.

7. The image forming apparatus according to claim 6,
wherein the threshold for the surface roughness includes a first surface threshold, and a second surface threshold larger than the first surface threshold,
the identifier decides whether the value indicating the surface roughness of the sheet is smaller than the first surface threshold,
the identifier identifies the sheet as a first sheet, when the value indicating the surface roughness of the sheet is smaller than the first surface threshold,
the identifier decides whether the value indicating the surface roughness of the sheet is smaller than the second surface threshold, when the value indicating the surface roughness of the sheet is not smaller than the first surface threshold,
the identifier identifies the sheet as a second sheet, different from the first sheet, when the value indicating the surface roughness of the sheet is smaller than the second surface threshold, and
the identifier identifies the sheet as a third sheet, different from the first sheet and the second sheet, when the value indicating the surface roughness of the sheet is not smaller than the second surface threshold.
